(19) United States
(12) Patent Application Publication
(10) Pub. No.: US 2019/0188634 A1
(43) Pub. Date: Jun. 20, 2019

(54) STOCK MANAGEMENT DEVICE, ITEM SALES SYSTEM AND STOCK MANAGEMENT METHOD

(71) Applicant: NEC Corporation, Minato-ku, Tokyo (JP)

(72) Inventors: Hiromi YAMAGUCHI, Tokyo (JP); Shinji NAKADAI, Tokyo (JP)

(73) Assignee: NEC Corporation, Minato-ku, Tokyo (JP)

(21) Appl. No.: 16/327,430

(22) PCT Filed: Aug. 22, 2017
(86) PCT No.: PCT/JP2017/029879

§ 371 Date: Feb. 22, 2019

(30) Foreign Application Priority Data
Aug. 23, 2016 (JP) 2016-162595

(51) Int. Cl. G06Q 10/08; G06Q 30/06

(52) U.S. Cl. CPC G06Q 10/087; G06Q 30/0635; G06Q 30/0639

(57) ABSTRACT

Provide a stock management device capable of providing both a benefit of online shopping and a benefit by using a mobile sales vehicle, and also being capable of delivering, to a customer doing online shopping, an item which the customer wants, even when the item is purchased at a mobile sales vehicle. This stock management device is provided with: management means for managing stock information about stock of an item held by each of a plurality of mobile sales vehicles; first reception means for receiving sales information; second reception means for receiving order information; transmission means for transmitting the order information to the mobile sales vehicle; and detection means for detecting the item included in the order information becoming out-of-stock, wherein, when the item becoming out-of-stock is detected, the transmission means transmits the order information to another mobile sales vehicle.

### TECHNICAL FIELD

The present disclosure relates to a stock management device, an item sales system, a stock management method, and a recording medium.

### BACKGROUND ART

There are an increasing use of online shopping to purchase an item through the Internet. Further, an item sales method called a mobile supermarket using a mobile sales vehicle has been proposed (NPL 1).

As a technology of combining the above, a technology of ordering, through a network, an item being sold by a mobile sales vehicle and purchasing the ordered item at a mobile sales vehicle is disclosed (PTL 1 and PTL 2).

Further, as a technology related to online shopping, for example, a method of supporting in-store picking of an item to be ordered is described in PTL 3.

Further, a technology of managing stock items in a plurality of distribution centers and stock items in a plurality of stores, and delivering an item ordered by a customer to the customer from a distribution center or a store having the item in stock and also being closest to a delivery address is described in PTL 4.

Further, a method of recommending another menu when a menu item is out of stock is described in PTL 5.

### CITATION LIST

### Patent Literature

PTL 1: Japanese Unexamined Patent Application Publication No. 2011-221984

PTL 2: Japanese Unexamined Patent Application Publication No. 2008-123278

PTL 3: Japanese Unexamined Patent Application Publication No. 2009-151623

PTL 4: Japanese Unexamined Patent Application Publication No. 1996-147374

PTL 5: Japanese Unexamined Patent Application Publication No. 2014-160305

### Non Patent Literature

NPL 1: “Mobile Supermarket Tokushimaru,” [online], [retrieved on Jul. 13, 2016], retrieved from the Internet: <http://www.tokushimaru.jp/>

### SUMMARY OF INVENTION

### Technical Problem

Item purchase by online shopping takes at least several hours from ordering of an item to delivery to the purchaser, and therefore it takes a long time for actual delivery after ordering. However, in the case of item purchase by online shopping, for example, there is a benefit that a customer staying indoors can receive an item without going outdoors. Further, selling by a mobile sales vehicle, items are displayed on a luggage carrier of the mobile sales vehicle as is the case with a common supermarket, and therefore a customer can actually take an item in hand and purchase the item at the mobile sales vehicle. Accordingly, for example, when a supermarket does not exist close to a customer and a mobile sales vehicle sells items close to the customer, there is a benefit that the customer can get an item to be purchased at a storefront of the mobile sales vehicle, without visiting a distant supermarket. A technology allowing a customer to acquire both such a benefit of online shopping and such a benefit by using a mobile sales vehicle is being sought. In order to acquire both of the benefits, the present inventors have found a method of unitarily managing stock of items being sold at a mobile sales vehicle and stock of items being sold on online shop. However, by unitarily managing the stock of items, when an item of which a customer doing online shopping wants to purchase is being sold at a mobile sales vehicle to be delivering the item to the customer, the item may be purchased by another customer using the mobile sales vehicle.

An object of the present disclosure is to provide a technology being capable of providing both a benefit of online shopping and a benefit by using a mobile sales vehicle, and also being capable of delivering, to a customer doing online shopping, an item which the customer wants, even when the item is purchased at a mobile sales vehicle.

### Solution to Problem

A stock management device according to one aspect of the present disclosure includes:

management means for managing stock information about stock of an item held by each of a plurality of mobile sales vehicles;

first reception means for receiving, from each of the plurality of mobile sales vehicles, sales information indicating an item sold at a storefront of the mobile sales vehicle;

second reception means for receiving, from a customer terminal, order information including information about an item ordered based on the stock information transmitted to the customer terminal;

transmission means for transmitting the order information to the mobile sales vehicle holding the ordered item included in the order information; and

detection means for detecting the item included in the order information becoming out-of-stock at the storefront of the mobile sales vehicle to which the order information has been transmitted, before the item is delivered to a delivery address, wherein,

when the item becoming out-of-stock is detected by the detection means, the transmission means transmits the order information to another mobile sales vehicle holding the ordered item included in the order information and being different from the mobile sales vehicle to which the order information has been transmitted, and

the management means updates the stock information based on at least one of the sales information and the order information.

An item sales system according to one aspect of the present disclosure includes:

a stock management device;

an on-board device being loaded on each of a plurality of mobile sales vehicles and transmitting, to the stock management device, sales information indicating an item sold at a storefront of each of the plurality of mobile sales vehicles; and

one or more customer terminals, wherein

the stock management device includes:
management means for managing stock information about stock of an item held by each of the plurality of mobile sales vehicles;
first reception means for receiving the sales information from each of the plurality of mobile sales vehicles;
second reception means for receiving, from the customer terminal, order information including information about an item ordered based on the stock information transmitted to the customer terminal;
transmission means for transmitting the order information to the mobile sales vehicle holding the ordered item included in the order information; and
detection means for detecting the item included in the order information becoming out-of-stock at a storefront of the mobile sales vehicle to which the order information has been transmitted, before the item is delivered to a delivery address, wherein,

when the item becoming out-of-stock is detected by the detection means, the transmission means transmits the order information to another mobile sales vehicle holding the ordered item included in the order information and being different from a mobile sales vehicle to which the order information has been transmitted, and

the management means updates the stock information, based on at least one of the sales information and the order information.

A stock management method according to one aspect of the present disclosure includes:

managing stock information about stock of an item held by each of a plurality of mobile sales vehicles;

receiving, from each of the plurality of mobile sales vehicles, sales information indicating an item sold at a storefront of the mobile sales vehicle;

receiving, from a customer terminal, order information including information about an item ordered based on the stock information transmitted to the customer terminal;

transmitting the order information to the mobile sales vehicle holding the ordered item included in the order information; and

detecting the item included in the order information becoming out-of-stock at the storefront of the mobile sales vehicle to which the order information has been transmitted, before the item is delivered to a delivery address, wherein,

when the item becoming out-of-stock is detected, transmitting the order information to another mobile sales vehicle holding the ordered item included in the order information and being different from the mobile sales vehicle to which the order information has been transmitted, and

updating the stock information based on at least one of the sales information and the order information.

A stock management method in an item sales system including a stock management device, an on-board device loaded on each of a plurality of mobile sales vehicles, and one or more customer terminals, the stock management method according to one aspect of the present disclosure includes:

managing, by the stock management device, stock information about stock of an item held by each of the plurality of mobile sales vehicles;

transmitting, by the on-board device, to the stock management device, sales information indicating an item sold at a storefront of a mobile sales vehicle loaded with the on-board device;

transmitting, by the customer terminal, to the stock management device, order information including information about an item ordered based on the stock information received from the stock management device;

receiving, by the stock management device, the sales information from the on-board device;

receiving, by the stock management device, the order information from the customer terminal;

transmitting, by the stock management device, the order information to the mobile sales vehicle holding the ordered item included in the order information; and

detecting, by the stock management device, the item included in the order information becoming out-of-stock at the storefront of the mobile sales vehicle to which the order information has been transmitted, before the item is delivered to a delivery address, wherein,

when the item becoming out-of-stock is detected, transmitting, by the stock management device, the order information to another mobile sales vehicle holding the ordered item included in the order information and being different from the mobile sales vehicle to which the order information has been transmitted, and

updating, by the stock management device, the stock information based on at least one of the sales information and the order information.

A computer program implementing the respective devices, the system, or the methods described above with a computer, and a computer-readable non-transitory recording medium storing the computer program are also included in the scope of the present disclosure.

### Advantageous Effects of Invention

The present disclosure can provide both a benefit of online shopping and a benefit by using a mobile sales vehicle, and can also deliver, to a customer doing online shopping, an item which the customer wants, even when the item is purchased at a mobile sales vehicle.

### BRIEF DESCRIPTION OF DRAWINGS

FIG. 1 is a functional block diagram illustrating a functional configuration example of a stock management device according to a first example embodiment.

FIG. 2 is a flowchart illustrating an example of a processing flow in the stock management device according to the first example embodiment.

FIG. 3 is a functional block diagram illustrating a functional configuration example of an item sales system including the stock management device according to the first example embodiment.

FIG. 4 is a flowchart illustrating an example of a processing flow in the item sales system including the stock management device according to the first example embodiment.

FIG. 5 is a block diagram illustrating a configuration example of an item sales system according to a second example embodiment.

FIG. 6 is a diagram for illustrating a use scene of the item sales system according to the second example embodiment.

FIG. 7 is a functional block diagram illustrating a functional configuration example of a stock management device in the item sales system according to the second example embodiment.

FIG. 8 is a diagram illustrating an example of stock information stored by a stock information storage unit according to the second example embodiment.

FIG. 9 is a diagram illustrating an example of customer information stored by a customer information storage unit according to the second example embodiment.

FIG. 10 is a functional block diagram illustrating a functional configuration example of an on-board device in the item sales system according to the second example embodiment.

FIG. 11 is a functional block diagram illustrating a functional configuration example of a customer terminal in the item sales system according to the second example embodiment.

FIG. 12 is a diagram illustrating an example of an ordering screen displayed by a display unit.

FIG. 13 is a flowchart illustrating an example of a processing flow of updating stock information, based on sales information, in the item sales system according to the second example embodiment.

FIG. 14 is a flowchart illustrating an example of a flow of transmission processing of present position information by the on-board device in the item sales system according to the second example embodiment.

FIG. 15 is a flowchart illustrating an example of a flow of sales processing of an item by online shopping in the item sales system according to the second example embodiment.

FIG. 16 is a flowchart illustrating an example of a flow of the sales processing of items by online shopping in the item sales system according to the second example embodiment.

FIG. 17 is a diagram exemplarily illustrating a hardware configuration of a computer (information processing device) capable of implementing the respective example embodiments.

### EXAMPLE EMBODIMENT

### First Example Embodiment

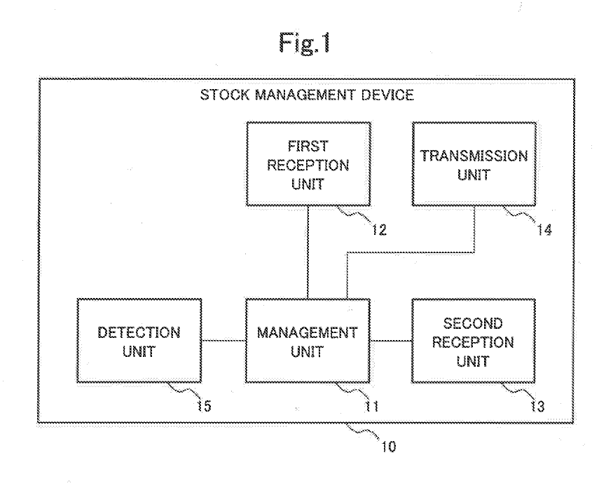

A first example embodiment of the present disclosure will be described with reference to drawings. A stock management device 10 managing stock information about stock of an item held by each of a plurality of mobile sales vehicles will be described in the present example embodiment. A mobile sales vehicle is a vehicle capable of moving to a predetermined location in accordance with a predetermined traveling route or in a predetermined area, and selling items loaded on a luggage carrier of the vehicle, at the destination. A mobile sales vehicle can also receive an order for an item loaded on the vehicle, while opening a luggage carrier and selling items loaded on the luggage carrier, or through a network while moving. Then, based on the received order, the mobile sales vehicle delivers the item to a customer who ordered. Thus, a mobile sales vehicle sells an item loaded on the mobile sales vehicle not only at its storefront but also through a network. Therefore, competition for sale of items displayed at the storefront may occur between sale at the storefront and sale through a network. In the present disclosure, a technology capable of providing both a benefit of online shopping and a benefit by using a mobile sales vehicle, even when competition for sale occurs as described above, will be described. FIG. 1 is a functional block diagram illustrating a functional configuration example of the stock management device 10 according to the present example embodiment. As illustrated in FIG. 1, the stock management device 10 according to the present example embodiment includes a management unit 11, a first reception unit 12, a second reception unit 13, a transmission unit 14 and a detection unit 15.

The management unit 11 manages stock information about stock of an item held by each of a plurality of mobile sales vehicles. The stock information includes at least information (for example, an item name and an item identifier) for identifying an item held by each of the plurality of mobile sales vehicles and a quantity of the item. The management unit 11 manages stock information for each mobile sales vehicle. The stock information managed by the management unit 11 may be stored in a storage unit provided inside the stock management device 10 or may be stored in a storage device separate from the stock management device 10.

Further, the management unit 11 updates stock information, based on sales information received by the first reception unit 12 and/or order information received by the second reception unit 13.

The first reception unit 12 receives, from each of a plurality of mobile sales vehicles, sales information indicating an item sold at a storefront of the mobile sales vehicle. The sales information includes at least information (for example, an item name and an item identifier) for identifying an item sold at a storefront of a mobile sales vehicle, and a quantity of the item. The first reception unit 12 provides the received sales information to the management unit 11.

The second reception unit 13 receives from a customer terminal order information including information about an item ordered based on stock information transmitted to the customer terminal. The stock information may be transmitted by any unit or a component (unillustrated) transmitting the stock information. The order information includes at least information for identifying a customer ordering an item, information (for example, an item name and an item identifier) for identifying the ordered item, the item being included in the stock information managed by the management unit 11, and a quantity of the item. The second reception unit 13 provides the received order information to the management unit 11.

The transmission unit 14 transmits order information to a mobile sales vehicle holding an ordered item included in the order information. Specifically, the transmission unit 14 receives from the management unit 11 information indicating a mobile sales vehicle holding an ordered item included in order information along with the order information and transmits the order information to the mobile sales vehicle.

Further, when the item becoming out-of-stock is detected by the detection unit 15, the transmission unit 14 transmits order information to another mobile sales vehicle holding the ordered item included in the order information and being different from the mobile sales vehicle to which the order information has been transmitted. Specifically, based on stock information managed by the management unit 11, the management unit 11 specifies another mobile sales vehicle being different from the mobile sales vehicle to which order information has been transmitted, and holding the item included in the order information. Then, the transmission unit 14 receives information about the specified another mobile sales vehicle from the management unit 11 and transmits the order information to the specified another mobile sales vehicle.

The detection unit 15 detects one or more items included in order information becoming out-of-stock at the storefront of the mobile sales vehicle to which the order information has been transmitted by the transmission unit 14, before the mobile sales vehicle delivers the item to a delivery address. For example, based on sales information, the detection unit 15 provides the management unit 11 with the detection result. Becoming out-of-stock according to the present example embodiment not only includes a case that a stock quantity becomes zero but also includes a case that a quantity of an item at a storefront of the mobile sales vehicle becomes less than a quantity of the item included in order information.

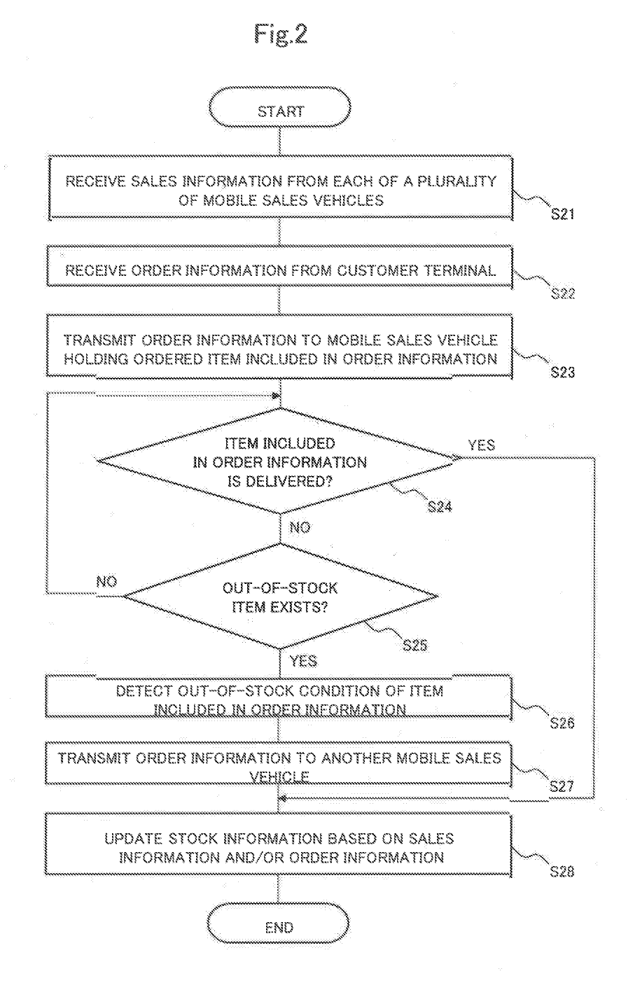

Next, a processing flow in the stock management device 10 according to the present example embodiment will be described with reference to FIG. 2. FIG. 2 is a flowchart illustrating an example of the processing flow in the stock management device 10 according to the present example embodiment. It is assumed in FIG. 2 that the management unit 11 in the stock management device 10 manages stock information about stock of an item held by a plurality of mobile sales vehicles, for each mobile sales vehicle. It is further assumed that the stock management device 10 transmits stock information to a customer terminal.

As illustrated in FIG. 2, first, the first reception unit 12 in the stock management device 10 receives, from each of a plurality of mobile sales vehicles, sales information indicating an item sold at a storefront of the mobile sales vehicle (Step S21).

Further, the second reception unit 13 receives from a customer terminal order information including information about an item ordered based on stock information transmitted to the customer terminal from the stock management device 10 (Step S22). Steps S21 and S22 may be performed at a time or in reverse order. Further, the processing in Step S21 is performed asynchronously with the processing in or after Step S22.

When Step S22 ends, the transmission unit 14 transmits the order information received in Step S22 to a mobile sales vehicle holding the ordered item included in the order information (Step S23).

Then, after Step S23 ends, the detection unit 15 confirms whether or not the mobile sales vehicle to which the order information has been transmitted delivers the item included in the order information to a delivery address (Step S24). When delivery of the item is completed (YES in Step S24), the stock management device 10 advances the processing to Step S28. When the delivery is not completed, that is, when the item included in the order information is not yet delivered to the delivery address (NO in Step S24), the stock management device 10 advances the processing to Step S25.

As described above, the stock management device 10 performs the processing in Step S21 asynchronously with the processing in and after Step S23. Accordingly, in and after Step S23, the stock management device 10 receives sales information from the mobile sales vehicle to which the order information has been transmitted. In other words, the aforementioned mobile sales vehicle sells the item at its storefront. Consequently, the item becoming out-of-stock may occur.

When there is no item becoming out-of-stock out of one or more items included in the order information at the storefront of the mobile sales vehicle to which the order information has been transmitted (NO in Step S25), the stock management device 10 returns the processing to Step S24. When there is an item becoming out-of-stock out of the items included in the order information at the storefront of the mobile sales vehicle to which the order information has been transmitted (YES in Step S25), the detection unit 15 detects the out-of-stock condition of the item (Step S26).

Then, the transmission unit 14 transmits the order information to another mobile sales vehicle holding the item included in the order information and being different from the mobile sales vehicle to which the order information has been transmitted in Step S23 (Step S27).

Then, the management unit 11 updates stock information, based on the sales information and/or the order information (Step S28). Specifically, when Step S21 ends, the management unit 11 updates stock information about stock of items held by the mobile sales vehicle transmitting the sales information, based on the sales information. When updating the stock information based on the order information, the management unit 11 updates stock information about stock of items held by the mobile sales vehicle to which the order information has been transmitted in Step S23 or S27.

The above concludes the processing by the stock management device 10.

As described above, the management unit 11 updates stock information, based on at least one of sales information received by the first reception unit 12 and order information received by the second reception unit 13. The stock management device 10 manages both stock for mobile sale by a mobile sales vehicle and stock for an online shop. Thus, the stock management device 10, for example, reflects stock for mobile sale in which items sold by mobile sale to stock for an online shop. Further, for example, when an order for an item is placed by an online shop, stock information about stock of items available for sale at a mobile sales vehicle is also updated. Consequently, both a customer using a mobile sales vehicle and a customer doing online shopping can confirm items in stock purchasable at the time. Accordingly, items held by a mobile sales vehicle can be sold both at the mobile sales vehicle and on an online shop.

Further, the transmission unit 14 transmits order information to a mobile sales vehicle holding an ordered item included in the order information. Consequently, a driver of a mobile sales vehicle receiving the order information can deliver an item to a customer who ordered the item held by the mobile sales vehicle.

Further, when the item included in order information becomes out-of-stock due to the item being sold at the storefront of the mobile sales vehicle receiving the order information before the item has been delivered to the delivery address by the mobile sales vehicle, the detection unit 15 detects the out-of-stock condition of the item. Then, the transmission unit 14 transmits the order information to another mobile sales vehicle different from the mobile sales vehicle to which the order information has been transmitted and holding the item included in the order information.

Consequently, a driver of the mobile sales vehicle receiving the order information can deliver the item held by the mobile sales vehicle to a customer placing the order.

Accordingly, the stock management device 10 according to the present example embodiment can deliver, to a customer doing online shopping, an item which the customer wants, even when the item is purchased at a mobile sales vehicle.

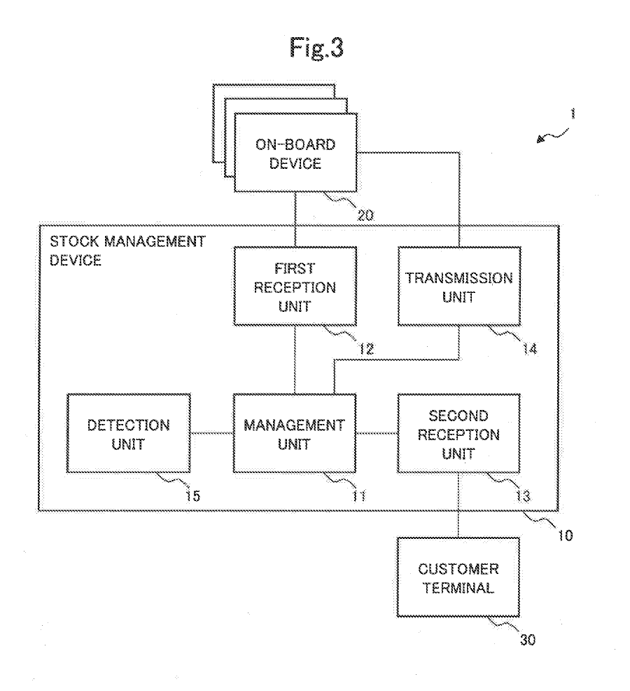

Further, an item sales system 1 including the stock management device 10 according to the present example embodiment will be described with reference to FIG. 3. FIG. 3 is a functional block diagram illustrating a functional configuration example of the item sales system 1 including the stock management device 10 according to the present example embodiment. As illustrated in FIG. 3, the item sales system 1 includes a stock management device 10, a plurality of on-board devices 20, and one or a plurality of customer terminals 30. The stock management device 10 included in FIG. 3 has a configuration similar to that of the stock management device 10 described by use of FIG. 1.

An on-board device 20 is loaded on each of a plurality of mobile sales vehicles and transmits to the stock management device 10 sales information indicating the item sold at the storefront of each of the plurality of mobile sales vehicles. A first reception unit 12 in the stock management device 10 receives the sales information.

Further, a second reception unit 13 in the stock management device 10 receives order information transmitted from each customer terminal 30.

A management unit 11 in the stock management device 10 updates stock information based on at least one of sales information received by the first reception unit 12 and order information received by the second reception unit 13.

Further, a transmission unit 14 transmits order information to an on-board device 20 on a mobile sales vehicle holding an ordered item included in the order information.

Further, a detection unit 15 detects the item included in order information becoming out-of-stock at the storefront of the mobile sales vehicle to which the order information has been transmitted by the transmission unit 14, before the mobile sales vehicle delivers the item to the delivery address. Then, based on the detection result by the detection unit 15, the transmission unit 14 transmits the order information to another mobile sales vehicle different from the mobile sales vehicle to which the order information has been transmitted. The “another” mobile sales vehicle is a mobile sales vehicle holding the item included in the order information.

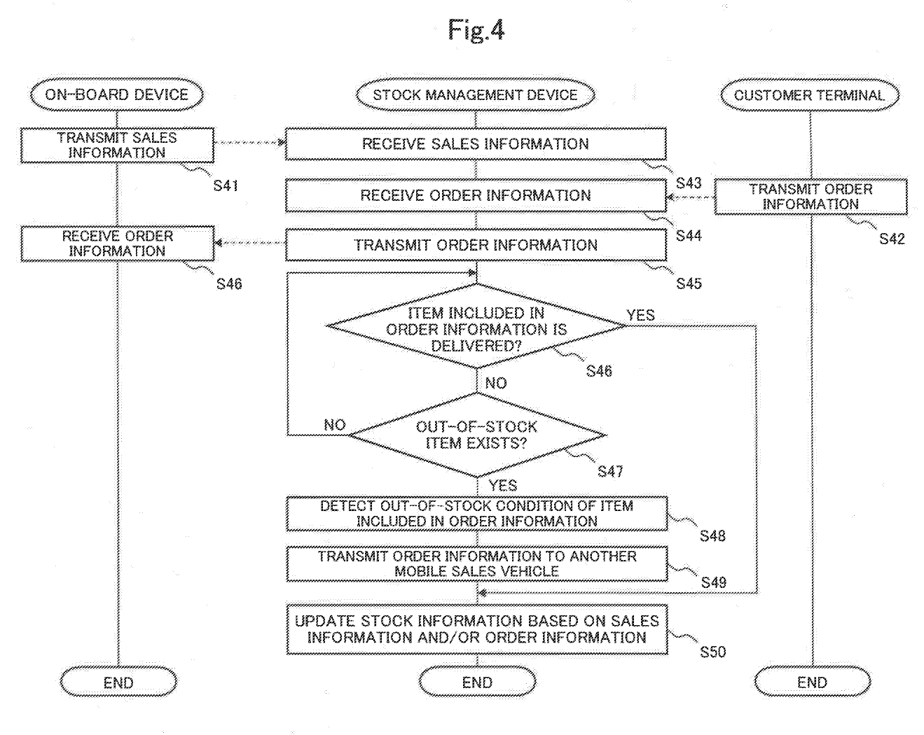

Next, a processing flow in the item sales system 1 including the stock management device 10 according to the present example embodiment will be described with reference to FIG. 4. FIG. 4 is a flowchart illustrating an example of the processing flow in the item sales system 1 including the stock management device 10 according to the present example embodiment. It is assumed in FIG. 4 that the management unit 11 in the stock management device 10 manages stock information about stock of an item held by a plurality of mobile sales vehicles, for each mobile sales vehicle. It is further assumed that the stock management device 10 transmits the stock information to a customer terminal 30. Further, in FIG. 4, processing by an on-board device 20 is described on the left, processing by the stock management device 10 at the center, and processing by a customer terminal 30 on the right; and a broken arrow between the respective processing steps represents a flow of primary information. An information flow is not limited to a direction of an arrow, and for example, an ACKnowledgement (ACK) may be transmitted in a direction reverse to the arrow.

As indicated in FIG. 4, an on-board device 20 transmits to the stock management device 10 sales information indicating an item sold at the storefront of the mobile sales vehicle loaded with the on-board device 20 (Step S41). Further, a customer terminal 30 transmits to the stock management device 10 order information including information about an item ordered based on the stock information received from the stock management device 10 (Step S42). Steps S41 and S42 are performed asynchronously, and an order thereof is not particularly limited.

When Step S41 ends, the first reception unit 12 in the stock management device 10 receives sales information indicating an item sold at the storefront from an on-board device 20 loaded on each of a plurality of mobile sales vehicles (Step S43). Further, when Step S42 ends, the second reception unit 13 in the stock management device 10 receives the order information from the customer terminal 30 (Step S44).

When Step S44 ends, the transmission unit 14 transmits the order information received in Step S44 to an on-board device 20 loaded on a mobile sales vehicle holding the ordered item included in the order information (Step S45).

Then, after Step S45 ends, the detection unit 15 confirms whether or not the mobile sales vehicle to which the order information has been transmitted has delivered the item included in the order information to the delivery address (Step S46). For example, the detection unit 15 confirms whether or not the mobile sales vehicle has delivered the item to the delivery address based on whether or not a delivery completion notification indicating delivery completion is received from the mobile sales vehicle. When the delivery of the item is completed (YES in Step S46), the stock management device 10 advances the processing to Step S50. When the delivery is not completed, that is, when the item included in the order information is not yet delivered to the delivery address (NO in Step S46), the stock management device 10 advances the processing to Step S47. When, at the storefront of the mobile sales vehicle to which the order information has been transmitted, there is no item becoming out-of-stock out of items included in the order information (NO in Step S47), the stock management device 10 returns the processing to Step S46. When, at the storefront of the mobile sales vehicle to which the order information has been transmitted, there is an item becoming out-of-stock out of the items included in the order information (YES in Step S47), the detection unit 15 detects the out-of-stock condition of the item (Step S48).

Then, the transmission unit 14 transmits the order information to another mobile sales vehicle holding the item included in the order information and being different from the mobile sales vehicle to which the order information has been transmitted in Step S45 (Step S49).

Then, the management unit 11 updates the stock information, based on the sales information and/or the order information (Step S50). Specifically, when updating the stock information based on the sales information, the management unit 11 updates the stock information about stock of items held by the mobile sales vehicle transmitting the sales information based on the sales information. When updating the stock information based on the order information, the management unit 11 updates the stock information about stock of items held by the mobile sales vehicle to which the order information has been transmitted in Step S45 or S49.

In the item sales system 1, when an item is purchased at a mobile sales vehicle loaded with an on-board device 20, Step S41 is executed again. Further, when an item is ordered by a customer terminal 30, Step S42 is executed again.

Thus, the stock management device 10 executes the processing illustrated in the flowchart in FIG. 4 every time a customer purchases an item.

As described above, in the item sales system 1, the management unit 11 in the stock management device 10 updates stock information, based on sales information received by the first reception unit 12 and order information received by the second reception unit 13. Further, the transmission unit 14 transmits order information to an on-board device 20 on a mobile sales vehicle holding the ordered item included in the order information. Then, when the item included in the order information becomes out-of-stock due to the item being sold at the storefront of the mobile sales vehicle to which the order information has been transmitted, the detection unit 15 detects the out-of-stock condition of the item. Then, the transmission unit 14 transmits the order information to an on-board device 20 on a mobile sales vehicle holding the item included in the order information, the mobile sales vehicle being different from the mobile sales vehicle loaded with the on-board device 20 to which the order information has been transmitted. Consequently, the “another” mobile sales vehicle loaded with the on-board device 20 can deliver the ordered item to a customer ordering the item.

Accordingly, the item sales system 1 including the stock management device 10 according to the present example embodiment can deliver, to a customer doing online shopping, an item which the customer wants, even when the item is purchased at a mobile sales vehicle.

### Second Example Embodiment

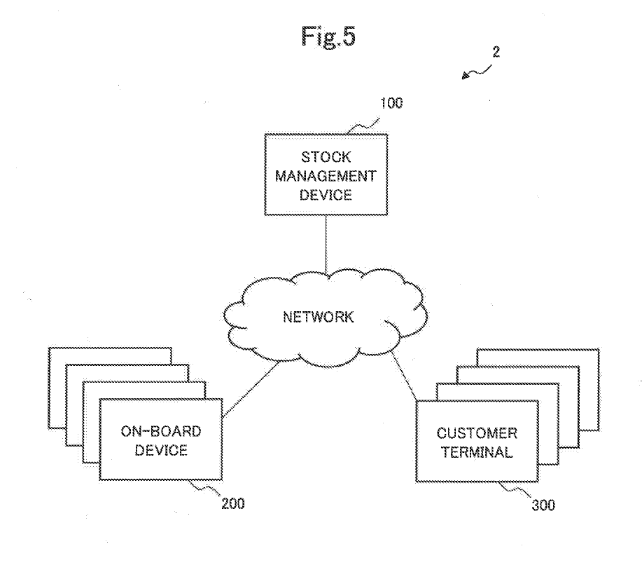

Next, a second example embodiment of the present disclosure based on the aforementioned first example embodiment will be described with reference to drawings. First, FIG. 5 illustrates a configuration example of an item sales system 2 according to the present example embodiment. As illustrated in FIG. 5, the item sales system 2 according to the present example embodiment includes a stock management device 100, a plurality of on-board devices 200, and one or a plurality of customer terminals 300. The stock management device 100 communicates with on-board devices 200 and customer terminals 300 through a network. A customer terminal 300 may be a mobile terminal or may be a desktop terminal.

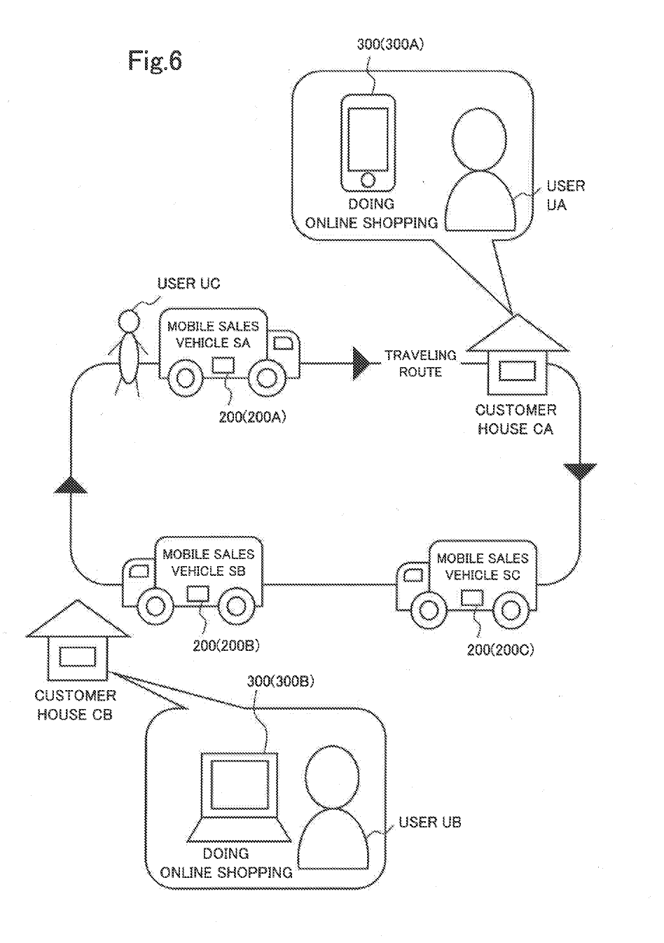

FIG. 6 is a diagram for illustrating a use scene of the item sales system 2 according to the present example embodiment. An on-board device 200 included in the item sales system 2 is a device loaded on each of a plurality of mobile sales vehicles. While FIG. 6 illustrates three mobile sales vehicles (SA, SB, SC), a number of mobile sales vehicle has only to be two or more. Further, while an on-board device 200 loaded on the mobile sales vehicle SA is referred to as an on-board device 200A, an on-board device 200 loaded on the mobile sales vehicle SB is referred to as an on-board device 200B, and an on-board device 200 loaded on the mobile sales vehicle SC is referred to as an on-board device 200C, the devices are simply referred to as on-board devices 200 when the devices are not distinguished or referred to by a general name.

For example, each of the mobile sales vehicles (SA, SB, SC) is a mobile-type supermarket traveling in accordance with a predetermined traveling route, stopping at a predetermined location, and selling an loaded item to a customer. The mobile sales vehicle may also be referred to as a mobile supermarket. Traveling routes according to which the plurality of mobile sales vehicles (SA, SB, SC) travel may be identical, different, or partially overlapping one another.

It is assumed that a user UC is a customer using a mobile sales vehicle, according to the present example embodiment. It is further assumed that a user UA living in a customer house CA is a customer doing online shopping by use of a customer terminal 300A. It is further assumed that a user UB living in a customer house CB is a customer doing online shopping by use of a customer terminal 300B. The customer terminal 300A and the customer terminal 300B are simply referred to as customer terminals 300 when the terminals are not distinguished or referred to by a general name. The customer house CA and the customer house CB may be houses facing roads on the traveling routes of the mobile sales vehicles (SA, SB, SC) or may be houses within a predetermined range from the traveling routes, respectively.

A store providing a service allowing a customer to do online shopping is hereinafter referred to as an online shop.

The item sales system 2 according to the present example embodiment provides both a customer using a mobile sales vehicle and a customer doing online shopping with benefits of using the respective means, by the stock management device 100 communicating with an on-board device 200 and a customer terminal 300.

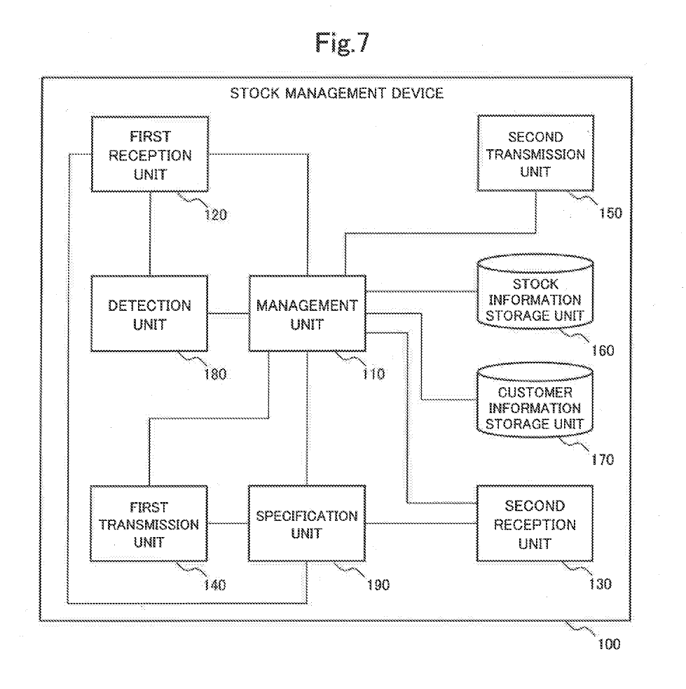

Next, a function of each device in the item sales system 2 according to the present example embodiment will be described in detail. FIG. 7 is a functional block diagram illustrating a functional configuration example of the stock management device 100 in the item sales system 2 according to the present example embodiment. As illustrated in FIG. 7, the stock management device 100 includes a management unit 110, a first reception unit 120, a second reception unit 130, a first transmission unit 140, a second transmission unit 150, a stock information storage unit 160, a customer information storage unit 170, a detection unit 180 and a specification unit 180.

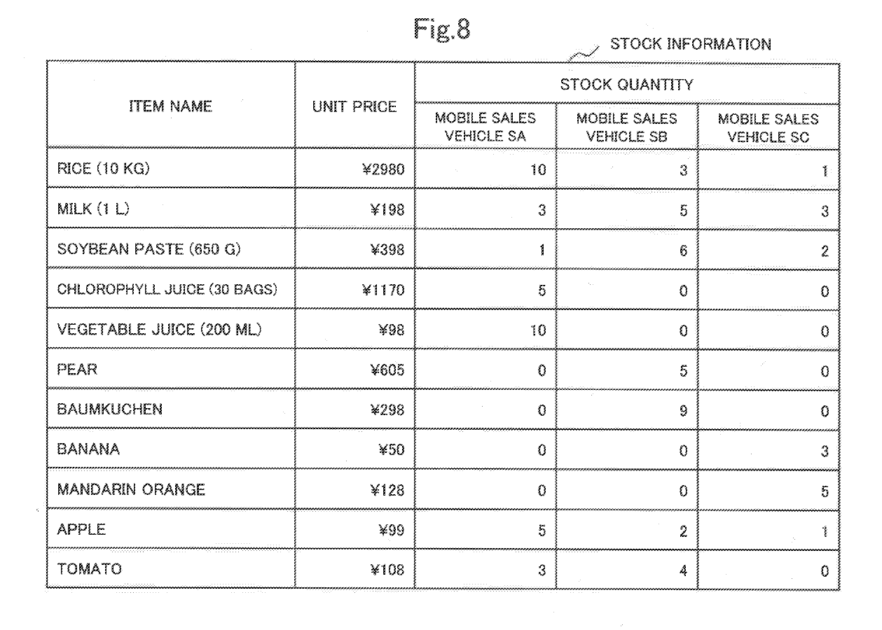

The stock information storage unit 160 stores stock information being information indicating stock of items held by each of a plurality of mobile sales vehicles. The stock information stored by the stock information storage unit 160 will be described with reference to FIG. 8. FIG. 8 is a diagram illustrating an example of stock information stored by the stock information storage unit 160 according to the present example embodiment. The stock information includes at least an item name being information for identifying an item held by each of a plurality of mobile sales vehicles, and a quantity of an item represented by the item name for each mobile sales vehicle. The stock information may include a unit price, as illustrated in FIG. 8. Information included in the stock information is not limited to the above.

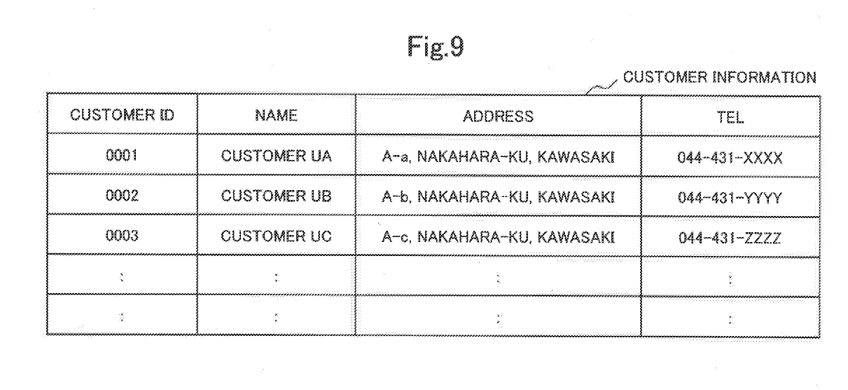

The customer information storage unit 170 stores customer information indicating information about a customer using a mobile sales vehicle and/or an online shop. The customer information stored by the customer information storage unit 170 will be described with reference to FIG. 9. FIG. 9 is a diagram illustrating an example of customer information stored by the customer information storage unit 170 according to the present example embodiment. The customer information includes a customer IDentifier (ID) for identifying a customer, a name of the customer, an address of the customer, and a telephone number of the customer. The customer information is not limited to the above and may include other information. Further, the customer information has only to include information by which a delivery address of an item can be identified. Further, for example, the customer information may include authentication information used for logging into an online shop. The customer information may be pre-registered when a service provided by the item sales system 2 is used. The registration method of the customer information is not particularly limited.

The stock information storage unit 160 and the customer information storage unit 170 may be implemented as separate storage units or may be implemented as the same storage unit. Further, the stock information storage unit 160 and the customer information storage unit 170 may be implemented as a storage device separate from the stock management device 100. Further, the stock information storage unit 160 and the customer information storage unit 170 may store stock information and customer information as databases, respectively.

The first reception unit 120 corresponds to the first reception unit 12 according to the first example embodiment. The first reception unit 120 receives from each of a plurality of mobile sales vehicles sales information indicating an item sold at its storefront. The sales information includes at least information (for example, an item name and an item identifier) for identifying an item sold at the storefront of the mobile sales vehicle and a quantity of the item. It is assumed below that the information for identifying an item is an item name. The first reception unit 120 provides the received sales information to the management unit 110 and the detection unit 180 along with information (referred to as mobile sales vehicle information) indicating a mobile sales vehicle loaded with an on-board device 200 being a source of the sales information. The mobile sales vehicle information may be an identifier for identifying a mobile sales vehicle, a license plate number of the mobile sales vehicle, a vehicle identification number of the mobile sales vehicle, a model name of the mobile sales vehicle, or the like.

Additionally, the first reception unit 120 further receives current position information indicating current positions of a plurality of mobile sales vehicles. The first reception unit 120 provides received current position information to the specification unit 190 along with mobile sales vehicle information indicating a mobile sales vehicle loaded with an on-board device 200 transmitting the current position information.

The second reception unit 130 corresponds to the second reception unit 13 according to the first example embodiment. The second reception unit 130 receives from a customer terminal 300 order information including information about an item ordered based on stock information transmitted to the customer terminal 300. The order information includes at least information for identifying a customer ordering an item, information (for example, an item name and an item identifier) for identifying the ordered item, the item being included in stock information managed by the management unit 110, and a quantity of the item. The second reception unit 130 provides the received order information to the management unit 110 and the specification unit 190. The order information received by the second reception unit 130 includes delivery address information indicating a delivery address designated by a customer.

The management unit 110 corresponds to the management unit 11 according to the first example embodiment. The management unit 110 manages stock information stored in the stock information storage unit 160. Further, the management unit 110 manages customer information stored in the customer information storage unit 170. Further, the management unit 110 may manage sales information and order information. The sales information and the order information may be stored and managed in a storage unit in the stock management device 100.

Information about stock items loaded on a mobile sales vehicle is registered in the stock information managed by the management unit 110 before each of a plurality of mobile sales vehicles starts mobile sale and also before the item being purchasable by online shopping. Then, the management unit 110 updates the stock information every time an item is purchased by mobile sale, every time an item is purchased by online shopping, and every time an item is carried in.

Further, the management unit 110 acquires, from the stock information storage unit 160, stock information to be transmitted to a customer terminal and provides the acquired stock information to the second transmission unit 150. At this time, the stock information acquired by the management unit 110 may be stock information about stock held by each of the mobile sales vehicles allowing a customer to purchase the items on an online shop at present, or may be stock information about stock held by mobile sales vehicles positioned within a predetermined range from a customer terminal, based on a position of the customer terminal. The mobile sales vehicle allowing a customer to purchase items on an online shop at present refers to, for example, a mobile sales vehicle capable of selling items on a luggage carrier at present, such as a mobile sales vehicle not being back in a garage, a mobile sales vehicle not all of items running out of stock, or a mobile sales vehicle not ending sale (not on the way back to a garage). Further, the stock information acquired by the management unit 110 may be, for example, stock information about stock held by a mobile sales vehicle positioned within a predetermined range from a delivery address when the delivery address is designated by a customer terminal. Further, the stock information acquired by the management unit 110 may be stock information about stock held by a mobile sales vehicle predesignated by a customer. Thus, the stock information acquired by the management unit 110 is not particularly limited.

Further, the management unit 110 updates stock information based on at least one of sales information and order information. For example, when sales information is transmitted from the on-board device 200A on the mobile sales vehicle SA, the management unit 110 updates stock information about stock of items held by the mobile sales vehicle SA based on the sales information.

Further, when the item included in the order information has been delivered to the delivery address by the mobile sales vehicle to which order information has been transmitted, the management unit 110 updates stock information about stock of items held by the mobile sales vehicle, based on the order information.

The specification unit 190 receives current position information from the first reception unit 120. Further, the specification unit 190 receives order information from the second reception unit 130. The specification unit 190 receives information about one or more mobile sales vehicles holding the item included in the order information from the management unit 110. Then, the specification unit 190 specifies one or more other mobile sales vehicles different from the mobile sales vehicle to which the first transmission unit 140 transmitted the order information, out of the mobile sales vehicles holding the items included in the order information and being indicated by the information about the mobile sales vehicles received from the management unit 110. Then, the specification unit 190 specifies one mobile sales vehicle arriving earliest at the delivery address out of the specified other mobile sales vehicles based on current positions of the mobile sales vehicles indicated by the current position information and a position of the delivery address indicated by delivery address information.

Furthermore, the specification unit 190 may specify the one mobile sales vehicle in consideration of information indicating whether or not a mobile sales vehicle is open for business, a storefront sales schedule, scheduled traveling route information, or the like. A mobile sales vehicle being open for business represents a state in which the mobile sales vehicle stops at a predetermined location, a loading platform is opened, and an item loaded on the mobile sales vehicle is ready to be sold to a customer. For example, the information indicating whether or not a mobile sales vehicle is open for business may be based on a signal indicating that a loading platform of the mobile sales vehicle is opened, the signal being transmitted from an on-board device 200 to the stock management device 100. Further, a storefront sales schedule indicates where and when a mobile sales vehicle is scheduled to perform mobile sale. The storefront sales schedule may be stored inside the stock management device 100 or may be transmitted from an on-board device 200. Further, scheduled traveling route information is information indicating a route on which a mobile sales vehicle is scheduled to travel. The scheduled traveling route information may be stored inside the stock management device 100 or may be transmitted from an on-board device 200. Further, the specification unit 190 may specify the one mobile sales vehicle in consideration of a traveling direction of a mobile sales vehicle, road information at that point in time, and the like. The traveling direction of a mobile sales vehicle and the road information may be transmitted from an on-board device 200. The road information may be information indicating a traffic jam or may be information preset to a road, such as one-way traffic. Further, the road information may be transmitted from an external server managing road information. The specification unit 190 provides the first transmission unit 140 with information indicating the specified one mobile sales vehicle.

The detection unit 180 corresponds to the detection unit 15 according to the first example embodiment. The detection unit 180 detects the item becoming out-of-stock at the storefront of the mobile sales vehicle to which order information has been transmitted by the first transmission unit 140. The item detected becoming out-of-stock is the item included in the order information. The detection unit 180 detects the item becoming out-of-stock before the item is delivered to the delivery address. The method of detecting the item becoming out-of-stock at the storefront of the mobile sales vehicle by the detection unit 180 may be, for example, a method based on sales information received by the first reception unit 120. For example, the detection unit 180 may detect an item becoming out-of-stock by acquiring, from the stock information storage unit 160 through the management unit 110, stock information about stock of items held by a mobile sales vehicle loaded with an on-board device 200 transmitting sales information, and comparing the acquired quantity of stock items with a quantity of items included in the sales information. According to the present example embodiment, becoming out-of-stock includes not only a case that a stock quantity becomes zero but also includes a case that the stock quantity becomes less than a quantity of items included in order information at a storefront of a mobile sales vehicle. In this case, the detection unit 180 may detect items becoming out-of-stock by use of a quantity of stock items, a quantity of items included in sales information, and a quantity of items included in the order information. The detection unit 180 provides the management unit 110 with the detection result.

The first transmission unit 140 corresponds to the transmission unit 14 according to the first example embodiment. The first transmission unit 140 receives, from the management unit 110, information indicating a mobile sales vehicle holding an ordered item included in order information along with the order information, and transmits the order information to an on-board device 200 loaded on the mobile sales vehicle.

Further, when an item becoming out-of-stock is detected by the detection unit 180, the first transmission unit 140 transmits order information to another mobile sales vehicle holding the ordered item included in the order information and being different from a mobile sales vehicle to which the order information has been transmitted. Specifically, the first transmission unit 140 receives information about another mobile sales vehicle specified by the specification unit 190 from the specification unit 190. Then, the first transmission unit 140 transmits order information to an on-board device 200 loaded on the specified another mobile sales vehicle indicated by the received information about the specified another mobile sales vehicle. The first transmission unit 140 may transmit, to the specified another mobile sales vehicle, only order information about the out-of-stock item in the order information.

Further, when transmitting order information to another mobile sales vehicle, the first transmission unit 140 may transmit an instruction to cancel the order information to the mobile sales vehicle to which the order information has been transmitted. When transmitting, to the specified another mobile sales vehicle, only order information about an out-of-stock item in the order information, the first transmission unit 140 may transmit an instruction to cancel only the order information about the out-of-stock item to the mobile sales vehicle to which the order information has been transmitted.

The second transmission unit 150 receives stock information from the management unit 110. The second transmission unit 150 transmits the stock information to a customer terminal 300. For example, when a browser is activated on a customer terminal 300, the second transmission unit 150 may generate a screen including stock information and transmit the generated screen to the customer terminal 300. Further, for example, when an application is activated on a customer terminal 300, the second transmission unit 150 may transmit information including stock information to the customer terminal 300 in such a way that the application can display a screen including the stock information. When a customer terminal 300 can display a screen including stock information, the second transmission unit 150 may transmit stock information itself acquired by the management unit 110. It is preferable that a timing when the second transmission unit 150 transmits stock information to a customer terminal 300 be after detecting that a customer performs an operation for purchasing an item by use of the customer terminal 300. For example, detecting that a customer performs an operation for purchasing an item by use of the customer terminal 300 includes detecting that the stock management device 100 has received login information from a customer terminal 300 by the customer inputting the login information to the customer terminal 300 for logging into an online shop. Consequently, the customer using the customer terminal 300 can confirm stock information at a timing of logging into the online shop.

Further, every time stock information is updated, the second transmission unit 150 may further transmit the updated stock information to a customer terminal 300. Consequently, a customer using the customer terminal 300 can confirm latest stock information at a time of an update.

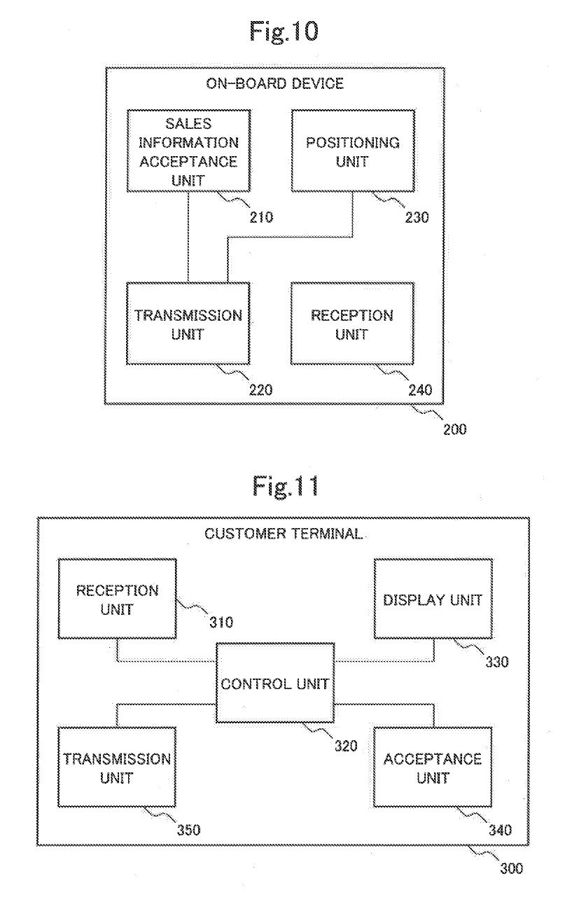

Next, a functional configuration of an on-board device 200 will be described with reference to FIG. 10. FIG. 10 is a functional block diagram illustrating a functional configuration example of an on-board device 200 in the item sales system 2 according to the present example embodiment. The on-board device 200 includes a sales information acceptance unit 210, a transmission unit 220, a positioning unit 230, and a reception unit 240.

The sales information acceptance unit 210 accepts sales information including an item name of an item sold by a mobile sale (an item purchased by a customer) of a mobile sales vehicle loaded with the on-board device 200, and a quantity of the item. For example, the sales information acceptance unit 210 is implemented with a point of sales (POS) register. The sales information acceptance unit 210 provides the accepted sales information to the transmission unit 220.

For example, the positioning unit 230 receives positional information by use of the Global Positioning System (GPS), and from the received positional information, measures a current position of a mobile sales vehicle loaded with the on-board device 200. A means used for measurement of a current position is not limited to the GPS. The positioning unit 230 may measure a current position by use of other information. The positioning unit 230 provides information (current position information) indicating a current position being a measurement result to the transmission unit 220.

When receiving sales information from the sales information acceptance unit 210, the transmission unit 220 transmits the sales information to the stock management device 100. Further, when receiving current position information from the positioning unit 230, the transmission unit 220 transmits the current position information to the stock management device 100.

Further, when the item included in order information has been delivered to the delivery address, the transmission unit 220 transmits a notification that delivery is completed (referred to as a delivery completion notification) to the stock management device 100.

The reception unit 240 receives order information transmitted from the stock management device 100. Consequently, a mobile sales vehicle loaded with the on-board device 200 receiving the order information can deliver the ordered item to the delivery address indicated by delivery address information, based on the order information. Further, when receiving an instruction to cancel order information with respect to received order information, the reception unit 240 cancels the order information. Consequently, the mobile sales vehicle loaded with the on-board device 200 does not perform delivery based on the cancelled order information. Accordingly, only the mobile sales vehicle receiving the order information can deliver the item included in the order information to the delivery address.

Next, a functional configuration of a customer terminal 300 will be described with reference to FIG. 11. FIG. 11 is a functional block diagram illustrating a functional configuration example of a customer terminal 300 in the item sales system 2 according to the present example embodiment. As illustrated in FIG. 11, the customer terminal 300 includes a reception unit 310, a control unit 320, a display unit 330, an acceptance unit 340, and a transmission unit 350.

The reception unit 310 receives stock information from the stock management device 100. The stock information has only to include information required for displaying information about stock of an item held by a mobile sales vehicle on the display unit 330 and may be, for example, the stock information itself stored in the stock information storage unit 160, part of the stock information, or processed stock information. The reception unit 310 provides the received stock information to the control unit 320.

The display unit 330 displays a screen in accordance with an instruction by the control unit 320. For example, the display unit 330 is implemented with a liquid crystal display. The display unit 330 may be implemented with a display device separate from the customer terminal 300.

The acceptance unit 340 accepts an instruction from a user using the customer terminal 300. For example, the acceptance unit 340 accepts an instruction from a user input through an input device such as a mouse or a keyboard. The acceptance unit 340 provides the accepted instruction to the control unit 320.

The acceptance unit 340 and the display unit 330 may be integrally formed as a touch panel.

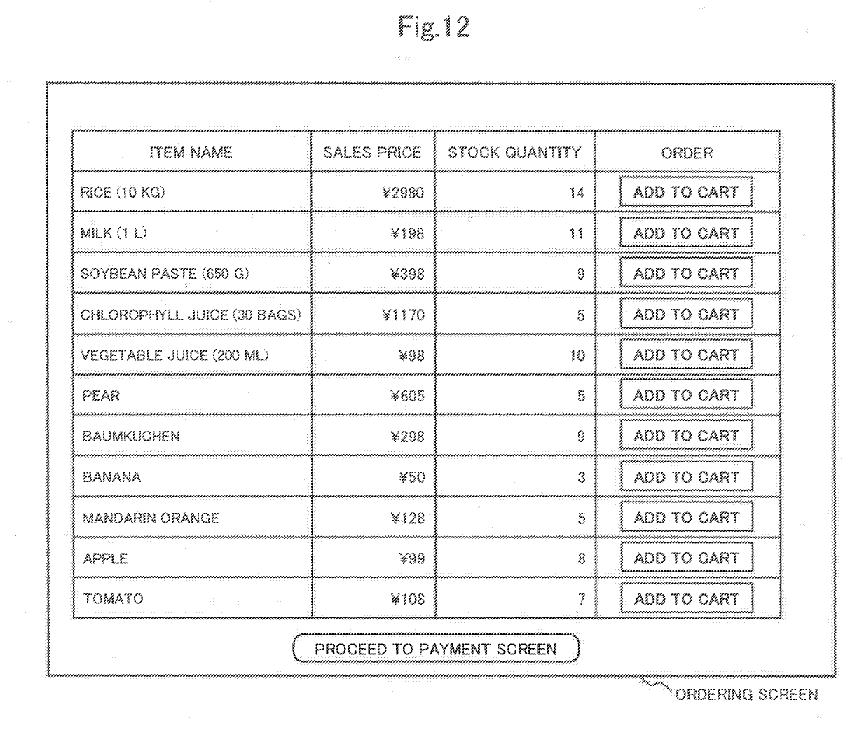

The control unit 320 controls the display unit 330 to display a screen based on the stock information received by the reception unit 310. A screen based on the stock information, the control unit 320 controlling the display unit 330 to display the screen, will be described with reference to FIG. 12. FIG. 12 is a diagram illustrating an example of a screen (ordering screen) displayed by the display unit 330.

An ordering screen illustrated in FIG. 12 displays information about items included in the stock information illustrated in FIG. 8. Thus, the control unit 320 causes the display unit 330 to display a screen (ordering screen) based on stock information.

An “ADD TO CART” button in FIG. 12 is a button for accepting an instruction to add a relevant item to a cart on an online shop. In accordance with the instruction, the control unit 320 keeps information of the item added to the cart as cart information. The cart information includes information for identifying an item and a quantity of the item.

A “PROCEED TO PAYMENT SCREEN” button in FIG. 12 is a button for transition to a screen for making payment. A payment method can be selected on the payment screen. The payment method is not particularly limited, and therefore description is omitted in the present example embodiment. When an instruction to make payment is input, the acceptance unit 340 accepts the instruction. Then, in accordance with the instruction to make payment (that is, an instruction that the shopping is finished), the control unit 320 provides information kept as cart information and information for identifying a customer to the transmission unit 350 as order information.

When receiving order information from the control unit 320, the transmission unit 350 transmits the order information to the stock management device 100.

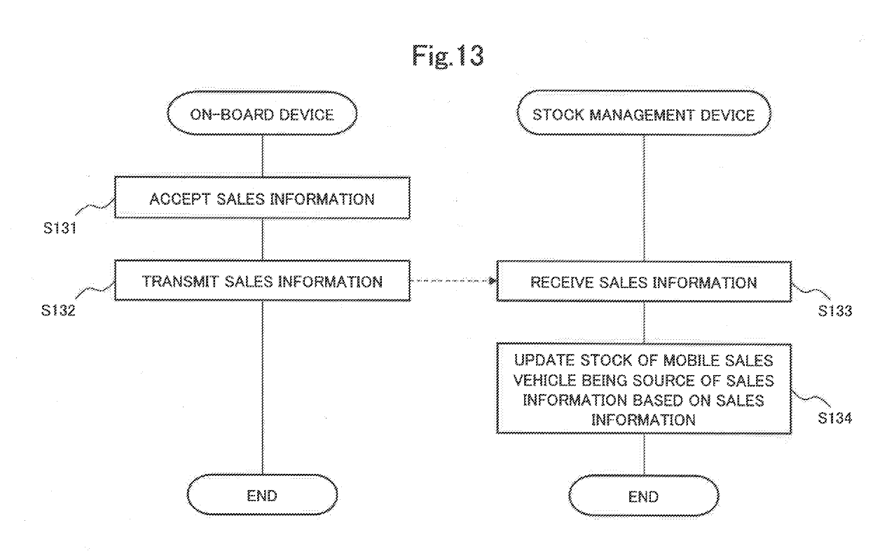

Next, processing of updating stock information, based on sales information, in the item sales system 2 will be described with reference to FIG. 13. FIG. 13 is a flowchart illustrating an example of a flow of the processing of updating stock information, based on sales information, in the item sales system 2 according to the present example embodiment.

It is assumed in FIG. 13 that the management unit 110 in the stock management device 100 manages stock information about stock of an item held by a plurality of mobile sales vehicles, for each mobile sales vehicle. Further, in FIG. 13, processing by an on-board device 200 is described on the left and processing by the stock management device 100 on the right; and a broken arrow between the respective processing steps represents a flow of primary information. An information flow is not limited to a direction of an arrow, and for example, an ACK may be transmitted in a direction reverse to the arrow.

First, the sales information acceptance unit 210 in the on-board device 200 accepts sales information including an item name of an item sold by a mobile sale (an item purchased by a customer) of a mobile sales vehicle loaded with the on-board device 200, and a quantity of the item (Step S131). Then, the transmission unit 220 transmits the sales information to the stock management device 100 (Step S132).

The first reception unit 120 in the stock management device 100 receives the sales information transmitted from the on-board device 200 (Step S133). The first reception unit 120 provides the sales information to the management unit 110 along with mobile sales vehicle information.

Based on the sales information provided from the first reception unit 120, the management unit 110 updates stock information about stock held by the mobile sales vehicle specified by the mobile sales vehicle information transmitted along with the sales information (Step S134).

The above concludes the processing of updating stock information based on sales information.

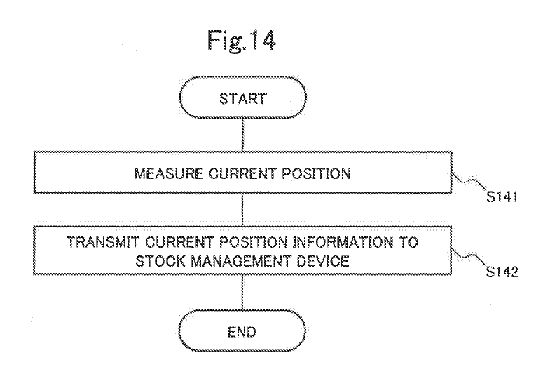

Next, transmission processing of current position information by an on-board device 200 will be described with reference to FIG. 14. FIG. 14 is a flowchart illustrating an example of a flow of the transmission processing of current position information by an on-board device 200 in the item sales system 2 according to the present example embodiment. The processing illustrated in FIG. 14 is performed asynchronously with the processing of updating stock information illustrated in FIG. 13.

As described in FIG. 14, the positioning unit 230 measures a current position (Step S141). The positioning unit 230 provides current position information being the measurement result to the transmission unit 220. Then, the transmission unit 220 transmits the current position information to the stock management device 100 (Step S142).

The above concludes the transmission processing of current position information by an on-board device 200.

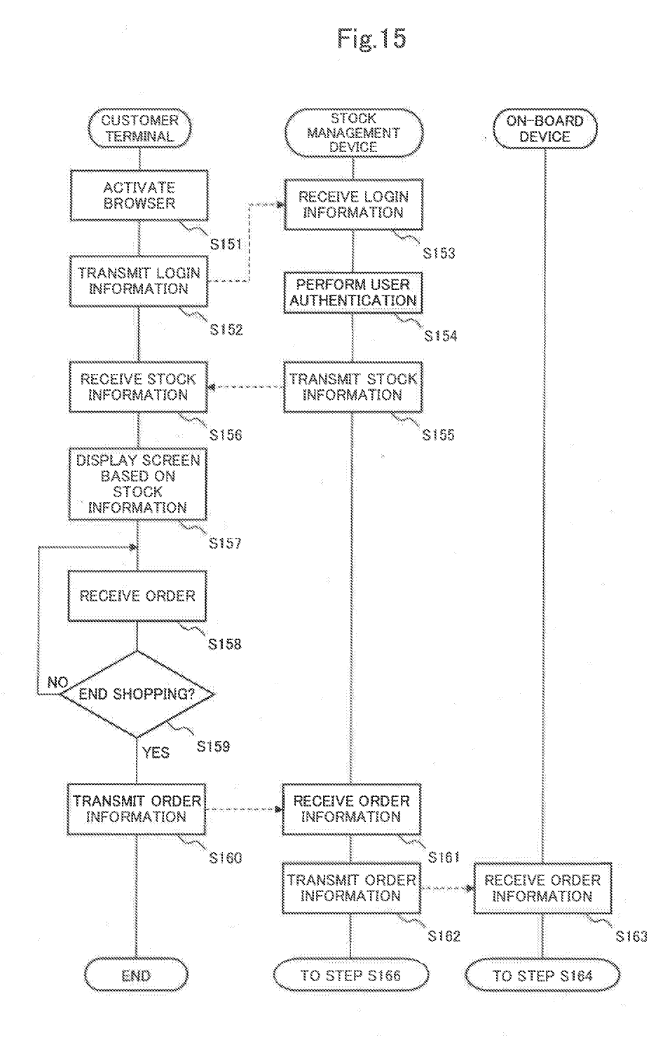

Next, sales processing of an item by online shopping in the item sales system 2 will be described with reference to FIG. 15. FIG. 15 is a flowchart illustrating an example of a flow of the sales processing of an item by online shopping in the item sales system 2 according to the present example embodiment. The processing illustrated in FIG. 15 is performed asynchronously with the processing of updating stock information illustrated in FIG. 13 and the transmission processing of current position information illustrated in FIG. 14.

In FIG. 15, processing by a customer terminal 300 is described on the left, processing by the stock management device 100 at the center, and processing by an on-board device 200 on the right; and a broken arrow between the respective processing steps represents a flow of primary information. An information flow is not limited to a direction of an arrow, and for example, an ACK may be transmitted in a direction reverse to the arrow.

A user (customer) using a customer terminal 300 inputs an instruction to start online shopping into the customer terminal 300, and the acceptance unit 340 accepts a content of the instruction. For example, when an instruction to activate a browser is input in order to do online shopping, the control unit 320 activates the browser (Step S151). For example, when processing accepted by the acceptance unit 340 is an instruction to activate an application for doing online shopping, the control unit 320 activates the application installed on the customer terminal 300.

Then, the transmission unit 350 transmits information required for doing online shopping to the stock management device 100. For example, the transmission unit 350 transmits to the stock management device 100 login information, such as a customer ID and authentication information for logging into an online shop (Step S152). The login information may be input by a customer for each shopping.

When receiving the login information transmitted from the customer terminal 300 (Step S153), the second reception unit 130 in the stock management device 100 transmits the login information to the management unit 110. Then, the management unit 110 refers to the customer information storage unit 170 and performs user authentication (Step S154). The user authentication may use any method, and therefore description is omitted in the present example embodiment.

Subsequently, when the customer is authenticated, the management unit 110 acquires stock information stored in the stock information storage unit 160 and provides the acquired stock information to the second transmission unit 150. The second transmission unit 150 transmits the stock information provided from the management unit 110 to the customer terminal 300 transmitting the login information to the stock management device 100 (Step S155). A timing of transmission of the stock information by the second transmission unit 150 may be after the stock management device 100 receives a transmission instruction of the stock information from the customer terminal subsequently to performing the user authentication. The timing of transmission of the stock information by the second transmission unit 150 has only to be after detection of the customer starting shopping on an online shop by use of the customer terminal 300 (performing an operation for purchasing an item by use of the customer terminal 300) such as after the stock management device 100 receives the aforementioned transmission instruction of the stock information. Further, the item sales system 2 may be configured not to perform user authentication.

The reception unit 310 in the customer terminal 300 receives the stock information from the stock management device 100 (Step S156). Subsequently, the control unit 320 causes the display unit 330 to display a screen based on the received stock information (Step S157). Subsequently, by use of the screen displayed based on the stock information, the customer orders an item. For example, when the customer depresses an “ADD TO CART” button illustrated in FIG. 12, the customer terminal 300 receives an order of an item by the customer, by the acceptance unit 340 accepting the depression of the button (Step S158). Subsequently, when an instruction to end the shopping (an instruction to make payment) is input by the customer, the acceptance unit 340 accepts the instruction to end the shopping (YES in Step S159). The acceptance unit 340 repeats Steps S158 and S159 until accepting an instruction to end the shopping. Then, the transmission unit 350 transmits order information to the stock management device 100 (Step S160).

The second reception unit 130 in the stock management device 100 receives the order information from the customer terminal 300 (Step S161). Then, the first transmission unit 140 transmits the order information to an on-board device 200 loaded on a mobile sales vehicle holding the item included in the order information (Step S162). Then, the on-board device 200 receives the order information (Step S163).

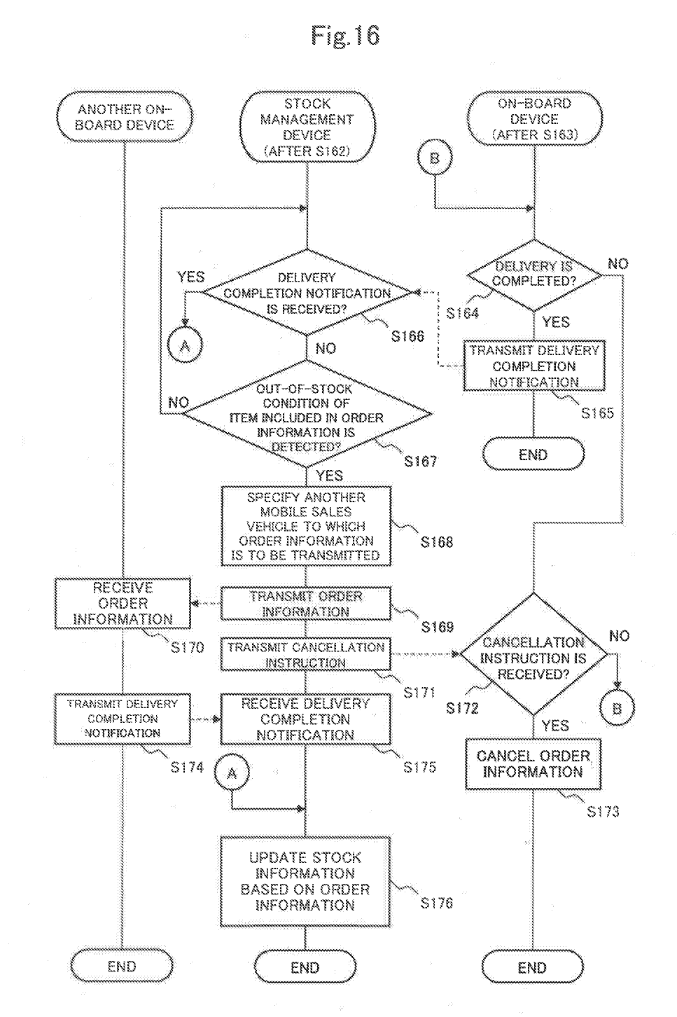

Processing in and after Step S164 will be described with reference to FIG. 16. In FIG. 16, processing by the stock management device 100 is described at the center, processing by the on-board device 200 described on the right in FIG. 15 is described on the right. Further, in FIG. 16, processing by an on-board device 200 on another mobile sales vehicle different from the mobile sales vehicle loaded with the on-board device 200 (referred to as another on-board device) indicated on the right in FIG. 15 is described on the left. Further, a broken arrow between the respective processing steps represents a flow of primary information. An information flow is not limited to a direction of an arrow, and for example, an ACK may be transmitted in a direction reverse to the arrow.

It is assumed that the order information received by the stock management device 100 in Step S161 includes an order of one “APPLE.” Then, it is assumed that the mobile sales vehicle loaded with the on-board device 200 receiving the order information in Step S163 is the mobile sales vehicle SC.

When the mobile sales vehicle SC completes delivery of the item included in the order information (YES in Step S164), the transmission unit 220 ends the processing on the order information by transmitting a delivery completion notification to the stock management device 100 (Step S165) and then proceeds to perform delivery or sell items at its storefront. When delivery of the item included in the order information is not completed (NO in Step S164), the on-board device 200 advances the processing to Step S172. As described above, the transmission processing of sales information illustrated in FIG. 13 is performed asynchronously with the processing in FIGS. 15 and 16, and therefore, in case where the mobile sales vehicle SC sells items at its storefront before execution of Step S172, the processing illustrated in FIG. 13 is performed.

The first reception unit 120 in the stock management device 100 confirms whether or not the delivery completion notification is received from the on-board device 200 (Step S166). When the delivery completion notification is received (YES in Step S166), the detection unit 180 determines that the mobile sales vehicle SC to which the order information has been transmitted has delivered the item included in the order information to the delivery address, and advances the processing to Step S176. The method of confirming, by the detection unit 180, whether or not the mobile sales vehicle to which the order information has been transmitted has delivered the item included in the order information to the delivery address is not limited to the above. Further, confirmation of whether or not the item has been delivered to the delivery address may be performed by another component (for example, the first reception unit 120) instead of the detection unit 180.

When the delivery completion notification is not received (NO in Step S166), the detection unit 180 detects a presence or absence of an item becoming out-of-stock at the storefront of the mobile sales vehicle SC, out of one or more items included in the order information (Step S167). Then, when an absence of an item becoming out-of-stock out of the items included in the order information is detected, that is, when an out-of-stock condition of one or more items included in the order information is not detected (NO in Step S167), the stock management device 100 returns the processing to Step S166. When a presence of an item becoming out-of-stock out of the items included in the order information is detected, that is, when an out-of-stock condition of one or more items included in the order information is detected (YES in Step S167), the specification unit 190 specifies another mobile sales vehicle arriving earliest at the delivery address, based on current positions of mobile sales vehicles indicated by current position information and a position of the delivery address indicated by delivery address information (Step S168). The mobile sales vehicle to be specified is a mobile sales vehicle holding the items included in the order information. It is assumed here that the specification unit 190 specifies the mobile sales vehicle SB.

Then, the first transmission unit 140 transmits the order information to the on-board device 200 on the mobile sales vehicle SB (Step S169). Consequently, the reception unit 240 in the on-board device 200B on the mobile sales vehicle SB receives the order information (Step S170).

The first transmission unit 140 also transmits a cancellation instruction to the on-board device 200C on the mobile sales vehicle SC (Step S171). Steps S169 and S171 may be performed at a time or may be performed in reverse order.

When the cancellation instruction is not received by the reception unit 240 in the on-board device 200C on the mobile sales vehicle SC (NO in Step S172), the on-board device 200 returns the processing to Step S164. When the cancellation instruction is received (YES in Step S172), the reception unit 240 cancels the order information received in Step S163 (Step S173).

When the item (one apple) included in the order information becomes sold out at the storefront of the mobile sales vehicle SB before the mobile sales vehicle SB delivers the item (apple) to the delivery address, the detection unit 180 detects the sellout, the order information is transmitted to another mobile sales vehicle (for example, the mobile sales vehicle SA), and a cancellation instruction is transmitted to the mobile sales vehicle SB.

The following description assumes that the mobile sales vehicle SB has delivered the item included in the order information to the delivery address.

When the transmission unit 220 in the on-board device 200B on the mobile sales vehicle SB transmits a delivery completion notification to the stock management device 100 (Step S174), the first reception unit 120 in the stock management device 100 receives the delivery completion notification (Step S175).

Then, the management unit 110 updates the stock information, based on the order information (Step S176). As described above, the item (one apple) included in the order information has been delivered to the delivery address by the mobile sales vehicle SB, and therefore the management unit 110 decreases the stock quantity of “APPLE” in the stock information illustrated in FIG. 8 by one, the stock information being about stock of items held by the mobile sales vehicle SB.

The above concludes the sales processing of items by online shopping by the item sales system 2.

As described above, in the item sales system 2, the management unit 110 in the stock management device 100 updates stock information, based on sales information received by the first reception unit 120 and order information received by the second reception unit 130. Further, the first transmission unit 140 transmits order information to an on-board device 200 on a mobile sales vehicle holding an ordered item included in the order information. Then, when an item included in the order information becomes out-of-stock by the item being sold at the storefront of the mobile sales vehicle to which the order information has been transmitted, the detection unit 180 detects the item becoming out-of-stock. Then, the first transmission unit 140 transmits the order information to an on-board device 200 on a mobile sales vehicle holding the item included in the order information, the mobile sales vehicle being different from the mobile sales vehicle loaded with the on-board device 200 to which the order information has been transmitted. Consequently, the mobile sales vehicle loaded with the on-board device 200 can deliver the ordered item to a customer ordering the item.

Accordingly, the item sales system 2 including the stock management device 100 according to the present example embodiment can deliver, to a customer doing online shopping, an item which the customer wants, even when the item is purchased at a mobile sales vehicle.

### About Hardware Configuration

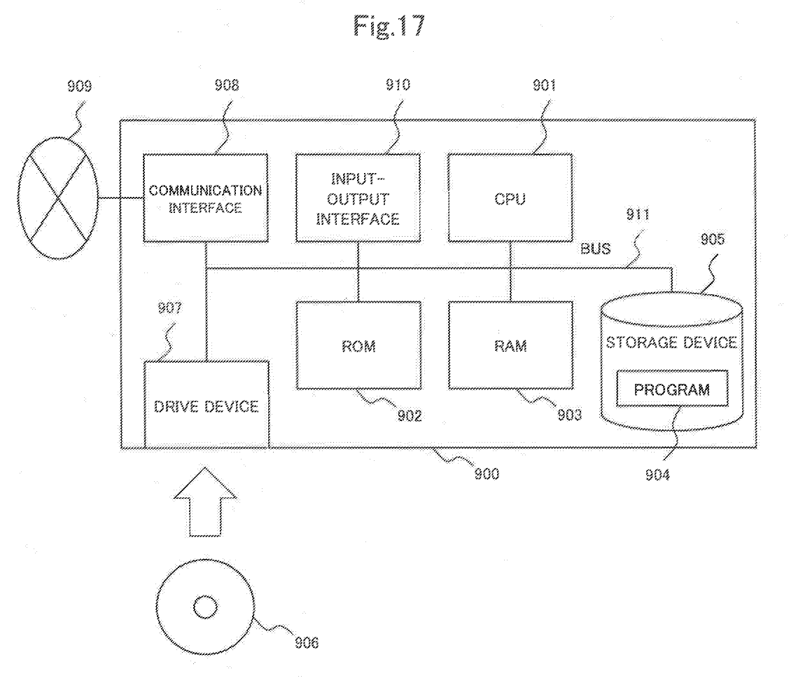

Each component in each of the stock management device, the on-board device, and the customer terminal, according to the respective example embodiments of the present disclosure, represents a functional unit block. For example, each component in each of the stock management device, the on-board device, and the customer terminal is implemented in part or in whole with any combination of an information processing device 900 as illustrated in FIG. 17 and a program. FIG. 17 is a block diagram illustrating a hardware configuration example of the information processing device 900 implementing each component in each of the stock management device, the on-board device, and the customer terminal. As an example, the information processing device 900 includes a configuration as described below.
A central processing unit (CPU) 901
A read only memory (ROM) 902
A random access memory (RAM) 903
A program 904 loaded into the RAM 903
A storage device 905 storing the program 904
A drive device 907 performing reading from and writing to a recording medium 906
A communication interface 908 connected to a communication network 909
An input-output interface 910 performing input and output of data
A bus 911 connecting the respective components

Each component in each of the stock management device, the on-board device, and the customer terminal, according to the respective example embodiments, is implemented by the CPU 901 acquiring and executing the program 904 implementing a function of the component. For example, the program 904 implementing the function of each component in each of the stock management device, the on-board device, and the customer terminal is pre-stored in the storage device 905 or the ROM 902, and is read by the CPU 901 as needed. The program 904 may be provided to the CPU 901 through the communication network 909; or the program may be pre-stored in the recording medium 906, and the drive device 907 may read the program and provide the program to the CPU 901.

There are various modified examples of the implementation method of each of the stock management device, the on-board device, and the customer terminal. For example, each of the stock management device, the on-board device, and the customer terminal may be implemented with any combination of a separate information processing device 900 and a program, for each component. Further, a plurality of components included in each of the stock management device, the on-board device, and the customer terminal may be implemented with any combination of a single information processing device 900 and a program.

Further, each component in each of the stock management device, the on-board device, and the customer terminal is implemented in part or in whole with another general-purpose or dedicated circuit, a processor, or the like, or a combination thereof. The above may be configured with a single chip or may be configured with a plurality of chips connected through a bus.

Each component in each of the stock management device, the on-board device, and the customer terminal may be implemented in part or in whole with a combination of the aforementioned circuit or the like, and a program.

When each component in each of the stock management device, the on-board device, and the customer terminal is implemented in part or in whole with a plurality of information processing devices, circuits, or the like, the plurality of information processing devices, circuits, or the like may be arranged in a concentrated manner or be arranged in a distributed manner. For example, the information processing devices, the circuits, or the like may be implemented in a form of being connected to one another through a communication network, such as a client-server system, a cloud computing system, or the like.

The respective aforementioned example embodiments are preferred example embodiments of the present disclosure, and the scope of the present disclosure is not limited to the respective aforementioned example embodiments; and a person skilled in the art can make example embodiments which include various changes through modifying and substituting the respective aforementioned example embodiments without departing from the spirit and scope of the present disclosure.

The aforementioned example embodiments may also be described in whole or in part as the following supplementary notes but are not limited thereto.

### (Supplementary Note 1)

A stock management device comprising:

management means for managing stock information about stock of an item held by each of a plurality of mobile sales vehicles;

first reception means for receiving, from each of the plurality of mobile sales vehicles, sales information indicating an item sold at a storefront of the mobile sales vehicle;

second reception means for receiving, from a customer terminal, order information including information about an item ordered based on the stock information transmitted to the customer terminal;

transmission means for transmitting the order information to the mobile sales vehicle holding the ordered item included in the order information; and

detection means for detecting the item included in the order information becoming out-of-stock at the storefront of the mobile sales vehicle to which the order information has been transmitted, before the item is delivered to a delivery address, wherein,

when the item becoming out-of-stock is detected by the detection means, the transmission means transmits the order information to another mobile sales vehicle holding the ordered item included in the order information and being different from the mobile sales vehicle to which the order information has been transmitted, and

the management means updates the stock information based on at least one of the sales information and the order information.

### (Supplementary Note 2)

The stock management device according to Supplementary note 1, wherein

the transmission means transmits an instruction to cancel the order information to a mobile sales vehicle to which the order information has been transmitted.

### (Supplementary Note 3)

The stock management device according to Supplementary note 1 or 2, wherein

the detection means detects the item becoming out-of-stock based on the sales information.

### (Supplementary Note 4)

The stock management device according to any one of Supplementary notes 1 to 3, wherein

the order information includes delivery address information indicating a delivery address of the item,

the first reception means further receives current position information indicating current positions of the plurality of mobile sales vehicles,

the stock management device further comprises: specification means for specifying a mobile sales vehicle arriving earliest at the delivery address out of one or more of the other mobile sales vehicles holding the ordered item, based on current positions of the mobile sales vehicles indicated by the current position information, and a position of the delivery address indicated by the delivery address information, and

the transmission means transmits the order information to the specified mobile sales vehicle.

### (Supplementary Note 5)

An item sales system comprising:

a stock management device;

an on-board device being loaded on each of a plurality of mobile sales vehicles and transmitting, to the stock management device, sales information indicating an item sold at a storefront of each of the plurality of mobile sales vehicles; and

one or more customer terminals, wherein

the stock management device includes:
management means for managing stock information about stock of an item held by each of the plurality of mobile sales vehicles;
first reception means for receiving the sales information from each of the plurality of mobile sales vehicles;
second reception means for receiving, from the customer terminal, order information including information about an item ordered based on the stock information transmitted to the customer terminal;
transmission means for transmitting the order information to the mobile sales vehicle holding the ordered item included in the order information; and
detection means for detecting the item included in the order information becoming out-of-stock at a storefront of the mobile sales vehicle to which the order information has been transmitted, before the item is delivered to a delivery address, wherein,

when the item becoming out-of-stock is detected by the detection means, the transmission means transmits the order information to another mobile sales vehicle holding the ordered item included in the order information and being different from a mobile sales vehicle to which the order information has been transmitted, and

the management means updates the stock information, based on at least one of the sales information and the order information.

### (Supplementary Note 6)

The item sales system according to Supplementary note 5, wherein

the transmission means transmits an instruction to cancel the order information to a mobile sales vehicle to which the order information has been transmitted.

### (Supplementary Note 7)

The item sales system according to Supplementary note 5 or 6, wherein

the detection means detects the item becoming out-of-stock based on the sales information.

### (Supplementary Note 8)

The item sales system according to any one of Supplementary notes 5 to 7, wherein

the order information includes delivery address information indicating a delivery address of the item,

the first reception means further receives current position information indicating current positions of the plurality of mobile sales vehicles,

the stock management device further comprises: specification means for specifying a mobile sales vehicle arriving earliest at the delivery address out of one or more of the other mobile sales vehicles holding the ordered item, based on current positions of the mobile sales vehicles indicated by the current position information, and a position of the delivery address indicated by the delivery address information, and

the transmission means transmits the order information to the specified mobile sales vehicle.

### (Supplementary Note 9)

A stock management method comprising:

managing stock information about stock of an item held by each of a plurality of mobile sales vehicles;

receiving, from each of the plurality of mobile sales vehicles, sales information indicating an item sold at a storefront of the mobile sales vehicle;

receiving, from a customer terminal, order information including information about an item ordered based on the stock information transmitted to the customer terminal;

transmitting the order information to the mobile sales vehicle holding the ordered item included in the order information; and

detecting the item included in the order information becoming out-of-stock at the storefront of the mobile sales vehicle to which the order information has been transmitted, before the item is delivered to a delivery address, wherein,

when the item becoming out-of-stock is detected, transmitting the order information to another mobile sales vehicle holding the ordered item included in the order information and being different from the mobile sales vehicle to which the order information has been transmitted, and

updating the stock information based on at least one of the sales information and the order information.

### (Supplementary Note 10)

The stock management method according to Supplementary note 9, further comprising:

transmitting an instruction to cancel the order information to a mobile sales vehicle to which the order information has been transmitted.

### (Supplementary Note 11)

A stock management method in an item sales system including a stock management device, an on-board device loaded on each of a plurality of mobile sales vehicles, and one or more customer terminals, the stock management method comprising:

managing, by the stock management device, stock information about stock of an item held by each of the plurality of mobile sales vehicles;

transmitting, by the on-board device, to the stock management device, sales information indicating an item sold at a storefront of a mobile sales vehicle loaded with the on-board device;

transmitting, by the customer terminal, to the stock management device, order information including information about an item ordered based on the stock information received from the stock management device;

receiving, by the stock management device, the sales information from the on-board device;

receiving, by the stock management device, the order information from the customer terminal;

transmitting, by the stock management device, the order information to the mobile sales vehicle holding the ordered item included in the order information; and

detecting, by the stock management device, the item included in the order information becoming out-of-stock at the storefront of the mobile sales vehicle to which the order information has been transmitted, before the item is delivered to a delivery address, wherein,

when the item becoming out-of-stock is detected, transmitting, by the stock management device, the order information to another mobile sales vehicle holding the ordered item included in the order information and being different from the mobile sales vehicle to which the order information has been transmitted, and

updating, by the stock management device, the stock information based on at least one of the sales information and the order information.

### (Supplementary Note 12)

The stock management method according to Supplementary note 11, further comprising:

transmitting, by the stock management device, an instruction to cancel the order information to a mobile sales vehicle to which the order information has been transmitted.

### (Supplementary Note 13)

A non-transitory computer readable storage medium storing a program that causes a computer to execute:

a process of managing stock information about stock of an item held by each of a plurality of mobile sales vehicles;

a process of receiving, from each of the plurality of mobile sales vehicles, sales information indicating an item sold at a storefront of the mobile sales vehicle;

a process of receiving, from a customer terminal, order information including information about an item ordered based on the stock information transmitted to the customer terminal;

a process of transmitting the order information to the mobile sales vehicle holding the ordered item included in the order information; and

a process of detecting the item included in the order information becoming out-of-stock at the storefront of the mobile sales vehicle to which the order information has been transmitted, before the item is delivered to a delivery address, wherein,

when the item becoming out-of-stock is detected by the detection means, a process of transmitting the order information to another mobile sales vehicle holding the ordered item included in the order information and being different from the mobile sales vehicle to which the order information has been transmitted, and

a process of updating the stock information based on at least one of the sales information and the order information.

### (Supplementary Note 14)

The storage medium according to Supplementary note 13, wherein, the program that causes a computer to execute:

a process of transmitting an instruction to cancel the order information to a mobile sales vehicle to which the order information has been transmitted.

This application claims priority based on Japanese Patent Application No. 2016-162595 filed on Aug. 23, 2016, the disclosure of which is hereby incorporated by reference thereto in its entirety.

### REFERENCE SIGNS LIST

1 Item sales system
2 Item sales system
10 Stock management device
11 Management unit
12 First reception unit
13 Second reception unit
14 Transmission unit
15 Detection unit
20 On-board device
30 Customer terminal
100 Stock management device
110 Management unit
120 First reception unit
130 Second reception unit
140 First transmission unit
150 Second transmission unit
160 Stock information storage unit
170 Customer information storage unit
180 Detection unit
190 Specification unit
200 On-board device
210 Sales information acceptance unit
220 Transmission unit
230 Positioning unit
240 Reception unit
300 Customer terminal
310 Reception unit
320 Control unit
330 Display unit
340 Acceptance unit
350 Transmission unit

What is claimed is:

1. A stock management device comprising:
a memory storing instructions; and
one or more processors configured to execute the instructions to:
manage stock information about stock of an item held by each of a plurality of mobile sales vehicles;
receive, from each of the plurality of mobile sales vehicles, sales information indicating an item sold at a storefront of the mobile sales vehicle;
receive, from a customer terminal, order information including information about an item ordered based on the stock information transmitted to the customer terminal;
transmit the order information to the mobile sales vehicle holding the ordered item included in the order information; and
detect the item included in the order information becoming out-of-stock at the storefront of the mobile sales vehicle to which the order information has been transmitted, before the item is delivered to a delivery address, wherein,
the one or more processors are further configured to execute the instructions to:
when the item becoming out-of-stock is detected, transmit the order information to another mobile sales vehicle holding the ordered item included in the order information and being different from the mobile sales vehicle to which the order information has been transmitted, and
update the stock information based on at least one of the sales information and the order information.

2. The stock management device according to claim 1, wherein
the one or more processors are further configured to execute the instructions to:
transmit an instruction to cancel the order information to a mobile sales vehicle to which the order information has been transmitted.

3. The stock management device according to claim 1, wherein
the one or more processors are further configured to execute the instructions to:
detect the item becoming out-of-stock based on the sales information.

4. The stock management device according to claim 1, wherein
the order information includes delivery address information indicating a delivery address of the item,
the one or more processors are further configured to execute the instructions to:
receive current position information indicating current positions of the plurality of mobile sales vehicles,
specify a mobile sales vehicle arriving earliest at the delivery address out of one or more of the other mobile sales vehicles holding the ordered item, based on current positions of the mobile sales vehicles indicated by the current position information, and a position of the delivery address indicated by the delivery address information, and
transmit the order information to the specified mobile sales vehicle.

5. An item sales system comprising:
a stock management device;
an on-board device being loaded on each of a plurality of mobile sales vehicles and transmitting, to the stock management device, sales information indicating an item sold at a storefront of each of the plurality of mobile sales vehicles; and
one or more customer terminals, wherein
the stock management device includes:
a memory storing instructions; and
one or more processors configured to execute the instructions to:
manage stock information about stock of an item held by each of the plurality of mobile sales vehicles;
receive the sales information from each of the plurality of mobile sales vehicles;
receive, from the customer terminal, order information including information about an item ordered based on the stock information transmitted to the customer terminal;
transmit the order information to the mobile sales vehicle holding the ordered item included in the order information; and
detect the item included in the order information becoming out-of-stock at a storefront of the mobile sales vehicle to which the order information has been transmitted, before the item is delivered to a delivery address, wherein,
the one or more processors are further configured to execute the instructions to:
when the item becoming out-of-stock is detected by the detection means, transmit the order information to another mobile sales vehicle holding the ordered item included in the order information and being different from a mobile sales vehicle to which the order information has been transmitted, and
update the stock information, based on at least one of the sales information and the order information.

6. The item sales system according to claim 5, wherein
the one or more processors are further configured to execute the instructions to:
transmit an instruction to cancel the order information to a mobile sales vehicle to which the order information has been transmitted.

7. The item sales system according to claim 5, wherein
the one or more processors are further configured to execute the instructions to:
detect the item becoming out-of-stock based on the sales information.

8. The item sales system according to claim 5, wherein
the order information includes delivery address information indicating a delivery address of the item,
the one or more processors are further configured to execute the instructions to:
receive current position information indicating current positions of the plurality of mobile sales vehicles,
specify a mobile sales vehicle arriving earliest at the delivery address out of one or more of the other mobile sales vehicles holding the ordered item, based on current positions of the mobile sales vehicles indicated by the current position information, and a position of the delivery address indicated by the delivery address information, and
transmit the order information to the specified mobile sales vehicle.

9. A stock management method comprising:
managing stock information about stock of an item held by each of a plurality of mobile sales vehicles;
receiving, from each of the plurality of mobile sales vehicles, sales information indicating an item sold at a storefront of the mobile sales vehicle;
receiving, from a customer terminal, order information including information about an item ordered based on the stock information transmitted to the customer terminal;
transmitting the order information to the mobile sales vehicle holding the ordered item included in the order information; and
detecting the item included in the order information becoming out-of-stock at the storefront of the mobile sales vehicle to which the order information has been transmitted, before the item is delivered to a delivery address, wherein,
when the item becoming out-of-stock is detected, transmitting the order information to another mobile sales vehicle holding the ordered item included in the order information and being different from the mobile sales vehicle to which the order information has been transmitted, and
updating the stock information based on at least one of the sales information and the order information.

10. The stock management method according to claim 9, further comprising:
transmitting an instruction to cancel the order information to a mobile sales vehicle to which the order information has been transmitted.

11-14. (canceled)
